(19) United States
(12) Patent Application Publication
(10) Pub. No.: US 2013/0281611 A1
(43) Pub. Date: Oct. 24, 2013

(54) RUBBER BLEND WITH AN ENVIRONMENTALLY-FRIENDLY PLASTICISER

(71) Applicant: Continental Reifen Deutschland GmbH, Hannover (DE)

(72) Inventors: Carla Recker, Hannover (DE); Thorsten Torbruegge, Langenhagen (DE)

(21) Appl. No.: 13/904,775

(22) Filed: May 29, 2013

Related U.S. Application Data
(63) Continuation of application No. PCT/EP2011/070534, filed on Nov. 21, 2011.

(30) Foreign Application Priority Data
Dec. 22, 2010 (DE) 10 2010 061 476.9

(51) Int. Cl. C08L 7/00; C08L 9/06; C08L 9/00

(52) U.S. Cl. CPC C08L 7/00; C08L 9/00; C08L 9/06
USPC 524/575; 524/571; 524/575.5

(57) ABSTRACT

A rubber blend, particularly for pneumatic vehicle tires, harnesses, straps and hoses. The rubber blend has the following composition: at least one polar or nonpolar rubber, at least one light and/or dark filler, at least one plasticizer which is free from polycyclic aromatic compounds and which has been produced based on waste materials containing carbon that result from the production of tires and additional technical rubber articles, as well as further additives.

### CROSS REFERENCE TO RELATED APPLICATIONS

This application is a continuation application of international patent application PCT/EP2011/070534, filed Nov. 21, 2011, designating the United States and claiming priority from German application 10 2010 061 476.9, filed Dec. 22, 2010, and the entire content of both applications is incorporated herein by reference.

### FIELD OF THE INVENTION

The invention relates to a rubber mixture, more particularly for pneumatic tires and for belts, drive-belts, and hoses.

### BACKGROUND OF THE INVENTION

It is the rubber constitution of the tread that to a large extent determines the traveling properties of a tire, especially of a vehicle's pneumatic tire. Similarly, the rubber mixtures which are used in drive-belts, hoses, and other belts, especially in those places subject to high mechanical loading, are substantially responsible for stability and longevity of these rubber products. Accordingly, the requirements imposed on these rubber mixtures for pneumatic tires, belts, drive-belts, and hoses are very exacting.

In recent years, the traveling properties of a tire, for example, have been brought overall to a higher level through the partial or complete replacement of the carbon black filler in rubber mixtures by silica. Even with silica-containing tread compounds, however, the known conflicts between contradictory tire properties nevertheless continue to exist. For instance, an improvement in wet grip and dry braking still generally entails a deterioration in the rolling resistance, winter properties, and abrasion behavior. Good grip and low abrasion are an important quality criterion for industrial rubber products as well, such as drive-belts and other belts.

In order to resolve these conflicts, diverse approaches have already been pursued. For example, use has been made of a very wide variety of different—including modified—polymers, resins, and highly disperse fillers for rubber mixtures, and attempts have been made to influence the vulcanisate properties by modifying the production of the mixtures.

Besides rubber and fillers, the plasticizers form another important class of adjuvants. Plasticizers are added to rubber mixtures in some cases in large quantities in order to lower the price of the mixture, to enhance its flow properties (energy savings on processing, prevention of energy spikes), to improve filler dispersion, to enhance the processing and adhesion behavior, and to influence the physical properties of the mixture and of the vulcanisates produced therefrom.

Generally speaking, the basis for virtually all of the plasticizers used in the rubber industry is crude oil. From an environmental standpoint, especially in relation to the existing pollutant emissions and raw materials scarcities, crude oil will in the future no longer be an acceptable starting material for the manufacture of rubber plasticizers. Alternatives being used include, for example, vegetable oils as plasticizers in rubber mixtures, as described in DE 101 08 981 A1 and U.S. Pat. No. 7,335,692, for example. The vegetable oils described therein can be used as the sole plasticizer, but are normally employed in combination with a further, crude oil-derived plasticizer. Even the vegetable oils, however, are not available in infinite quantities for the rubber industry.

As a further alternative, U.S. Pat. No. 8,236,875 describes the use of what are called BTL oils (Biomass-To-Liquid oils). In this case, solid biomasses are starting material for the production of the plasticizers, this production being able in turn to take place by way of a variety of modes of direct liquefaction.

### SUMMARY OF THE INVENTION

The object on which the invention is based, then, is that of providing a rubber mixture, more particularly for pneumatic tires and for belts, drive-belts, and hoses, that comprises at least one further alternative and eco-friendly plasticizer, thereby allowing a reduction in the pollutant emissions associated with the rubber mixture in service. The intention at the same time is to increase the sustainability and environmental compatibility of rubber mixtures and to ensure independence from crude oil as a raw materials source and energy source.

This object is achieved by means of a rubber mixture having the following composition:
at least one polar or nonpolar rubber and
at least one pale and/or dark filler, and
at least one plasticizer, the plasticizer being free from polycyclic aromatics, and the plasticizer having been produced on the basis of carbon-containing wastes from the production of tires and other industrial rubber products, and
further additives.

The quantity phr (parts per hundred parts of rubber by weight) used in this specification is the quantity indicator customary within the rubber industry for mixture formulations. The amount of the parts by weight of the individual substances is always here referred to 100 parts by weight of the total mass of all of the rubbers present in the mixture.

Surprisingly, it has been found that through the combination of at least one polar or nonpolar rubber, at least one pale and/or dark filler, further additives, customary in the rubber industry, and at least one plasticizer which is free from polycyclic aromatics and which has been produced on the basis of carbon-containing wastes from the production of tires and other industrial rubber products, an enhanced sustainability and environmental compatibility of rubber mixtures is ensured. At the same time, a plasticizer of this kind is not based on crude oil, and so here there is an independence from this raw materials and energy source. Also advantageous is the fact that carbon-containing wastes from tire production and from the production of other industrial rubber products are employed as starting material, meaning that these wastes do not pose an additional burden on the environment, but instead undergo a kind of “recycling”.

The carbon-containing wastes from the production of tires and other industrial rubber products are also referred to below as rubber wastes.

It is relevant here that the physical properties of the rubber mixture remain at the same level. This is so not only in respect of the vehicle treads, in the case of separated treads especially for the base, but also in respect of other internal tire components. The rubber mixtures for the other internal tire components are referred to collectively below, and as is usual within tire technology, as body compounds or body mixtures.

The rubber mixture of the invention finds further application in the development of mixtures for drive-belts, other belts, and hoses. These industrial rubber products find use everywhere within daily life, such as in elevators, in the automobile industry, in the raw materials industry, in the food industry, and in medical technology, for example. There as well, consequently, an improved environmental compatibility in conjunction with consistent mixture properties is of central importance.

The rubber mixture comprises at least one polar or nonpolar rubber. This polar or nonpolar rubber can be selected from the group consisting of natural polyisoprene and/or synthetic polyisoprene and/or butadiene rubber and/or styrene-butadiene rubber and/or solution-polymerized styrene-butadiene rubber and/or emulsion-polymerized styrene-butadiene rubber and/or liquid rubbers and/or halobutyl rubber and/or polynorbornene and/or isoprene-isobutylene copolymer and/or ethylene-propylene-diene rubber and/or nitrile rubber and/or chloroprene rubber and/or acrylate rubber and/or fluoro rubber and/or silicone rubber and/or polysulfide rubber and/or epichlorohydrin rubber and/or styrene-isoprene-butadiene terpolymer and/or hydrogenated acrylonitrile-butadiene rubber and/or isoprene-butadiene copolymer and/or hydrogenated styrene-butadiene rubber.

More particularly, nitrile rubber, hydrogenated acrylonitrile-butadiene rubber, chloroprene rubber, butyl rubber, halobutyl rubber, or ethylene-propylene-diene rubber is employed in the production of industrial rubber products, such as belts, drive-belts, and hoses.

It is nevertheless preferred for the rubber mixture to comprise natural and/or synthetic polyisoprene and to do so in amounts of 0 to 50 phr, preferably 0 to 40 phr, more preferably in amounts of 0 to 30 phr, more preferably still in amounts of 0 to 20 phr, but at least 0.1 phr, more particularly at least 0.5 phr. In one particular embodiment the polar or nonpolar rubber is a butadiene rubber which may have been hydrogenated. The butadiene rubber is used preferably in amounts of 2 to 60 phr, more preferably in amounts of 2 to 50 phr, very preferably in amounts of 5 to 50 phr, especially preferably in amounts of 10 to 50 phr, and more preferably still in amounts of 10 to 45 phr.

The polar or nonpolar rubber may be a styrene-butadiene rubber, which is preferably solution-polymerized or emulsion-polymerized. The styrene-butadiene rubber may be hydrogenated and in one particularly advantageous embodiment is solution-polymerized.

The styrene-butadiene rubber may have been modified, furthermore, with hydroxyl groups and/or epoxy groups and/or siloxane groups and/or amino groups and/or aminosiloxane and/or carboxyl groups and/or phthalo-cyanine groups. Further modifications known to the skilled person and also referred to as functionalizations are also suitable, however.

The styrene-butadiene rubber finds use in amounts of 2 to 98 phr, preferably 2 to 90 phr, more preferably 2 to 80 phr, more preferably still in amounts of 5 to 80 phr.

The rubber mixture of the invention further comprises at least one pale and/or dark filler. The total amount of filler may therefore consist only of pale or dark filler or of a combination of pale and dark fillers.

It is preferred if the pale filler is silica, preferably precipitated silica.

The rubber mixture of the invention contains 1 to 300 phr, preferably 1 to 250 phr, more preferably 1 to 200 phr, more preferably still 1 to 150 phr, very preferably 1 to 100 phr, of silica. Of this total amount of silica, 0% to 100% may be attached to the polymer matrix by a coupling agent, preferably silane, and/or 0% to 100% may not be attached to the polymer matrix. This means that, starting from the total amount of silica, the silica is attached to the polymer matrix by the coupling agent completely or only partially, or there is no attachment of the silica to the polymer matrix at all.

The silicas used within the tire industry are generally precipitated silicas which are characterized in particular according to their surface area. For this characterization, the nitrogen surface area (BET) in accordance with DIN 66131 and DIN 66132, as a measure of the internal and external filler surface area, in m²/g, and the CTAB surface area in accordance with ASTM D 3765, as a measure of the external surface area, often considered to be the rubber-active surface area, in m²/g, are quoted.

Silicas used in accordance with the invention are those having a nitrogen surface area of greater than or equal to 100 m²/g, preferably between 120 and 300 m²/g, more preferably between 140 and 250 m²/g, and a CTAB surface area of between 100 and 250 m²/g, preferably between 120 and 230 m²/g, and more preferably between 140 and 200 m²/g.

If a coupling agent in the form of silane or an organosilicon compound is used, then the amount of the coupling agent is 0 to 20 phr, preferably 0.1 to 15 phr, more preferably 0.5 to 10 phr. Coupling agents which can be used are all of the coupling agents known to the skilled person for use in rubber mixtures.

The dark filler preferably comprises carbon black, preferably in amounts of 0 to 100 phr, more preferably in amounts of 0 to 80 phr, with at least 0.1 phr, more particularly at least 0.5 phr, of at least one carbon black. In one particularly preferred embodiment the carbon black has an iodine number, in accordance with ASTM D 1510, also referred to as iodine absorption number, of greater than or equal to 75 g/kg and a DBP number of greater than or equal to 80 cm³/100 g. The DBP number in accordance with ASTM D 2414 defines the specific absorption volume of a carbon black or of a pale filler by means of dibutyl phthalate.

The use of a carbon black of this kind in the rubber mixture, more particularly for pneumatic tires of vehicles, ensures an optimum compromise between abrasion resistance and heat development, which in turn influences the environmentally relevant rolling resistance. It is preferred here for only one kind of carbon black to be used in each of the rubber mixtures, although different types of carbon black can also be mixed into the rubber mixture.

As noted above, the rubber mixture comprises at least one plasticizer which is free from polycyclic aromatics and which has been produced on the basis of carbon-containing wastes from the production of tires and other industrial rubber products.

Plasticizer oils have to date been produced generally on the basis of crude oil, the reserves of which are limited, the crude oil being a finite fossil source. In order to obtain independence from crude oil as raw material and energy source, and at the same time to achieve improved environmental compatibility, the plasticizer, which is free from polycyclic aromatics, derives from carbon-containing wastes that originate from tire manufacture or from the production of other industrial rubber products. Other industrial rubber products are, in particular, hoses, belts, drive-belts, seals, and membranes, the list recited not being complete. The waste materials may be green mixtures, that is, unvulcanized or partly vulcanized rubber mixtures, or may be rubber products that have already been vulcanized and possibly comminuted, such as used tires, used hoses, used belts, and used drive-belts, for example.

Polycyclic aromatics are classed as particularly environmentally debatable and are encountered, generally speaking, in numerous substances—presently plasticizers, more particularly—based on crude oil as raw material. Free from polycyclic aromatics, also referred to as polycyclic aromatic hydrocarbons, means that the amount of benzo(a)pyrene in the plasticizer must be less than 1 mg/kg and the sum total—in accordance with European Community Directive 76/769/EEC—of benzo(a)anthracene, chrysene, benzo(b)fluoran-thene, benzo(j)fluoranthene, benzo(k)fluoranthene, benzo(e)pyrene, benzo(a)pyrene, and dibenzo(a,h)-anthracene must be less than 10 mg/kg.

A plasticizer of this kind is preparable by analogy with the methods for producing BTL oils as already mentioned in U.S. Pat. No. 8,236,875. In this case as well, there is differentiation into two-stage processes, in which essentially, in a first process step in the production operation, a synthesis gas is generated by gasification and, in a second process step, a fuel is synthesized. Also known are direct processes, as already described in DE 102 15 679 A1 and DE 10 2005 040 490 A1, for example. Use may also be made, however, of further processes, of the kind known to the skilled person for the production of biomass-to-liquid, in order, from the carbon-containing wastes from the production of tires and other industrial rubber products, to prepare the plasticizers of the kind used in the rubber mixture of the invention. Mention may be made here, by way of example, of flash pyrolysis, with very short residence times in the reactor; direct hydrogenative liquefaction, where (pressurized) hydrogen during the pyrolysis produces stable product hydrocarbons; the process known as the Carbo-V process, which is based on the Fischer-Tropsch process; and direct catalytic liquefaction, where pyrolysis takes place in an oil reservoir with catalyst addition.

It has proven advantageous, however, if the plasticizer that is free from polycyclic aromatics has been produced by means of direct catalytic liquefaction.

In the processes and operations that are typically employed for the production of automobile fuels, there is often production of heavy oil fractions which are unwanted and are disposed of.

The direction of the processes for the targeted synthesis of an appropriate heavy oil fraction is also conceivable.

Surprisingly, it has been found that the heavy oil fractions produced in the direct liquefaction of carbon-containing rubber wastes are suitable as plasticizers, more particularly as plasticizer oil free from polycyclic aromatics, for rubber mixtures.

The plasticizer that is free from polycyclic aromatics is used in amounts of 0.1 to 150 phr, preferably in amounts of 0.1 to 120 phr, more preferably in amounts of 0.1 to 100 phr, more preferably still in amounts of 0.1 to 80 phr, very preferably in amounts of 0.1 to 60 phr.

It is also possible for there to be at least one additional plasticizer present in the rubber mixture. This further plasticizer is selected from the group consisting of mineral oils and/or synthetic plasticizers and/or fatty acids and/or fatty acid derivatives and/or resins and/or factices and/or glycerides and/or terpenes and/or vegetable oils and/or BTL oils and/or liquid polymers. When this additional plasticizer is used, the amount of this additional plasticizer or of the combination of additional plasticizers is preferably 0.1 to 20 phr, more preferably 0.1 to 10 phr, and very preferably 0.1 to 5 phr.

When mineral oil is used it is preferably selected from the group consisting of DAE (Distilled Aromatic Extracts) and/or RAE (Residual Aromatic Extracts) and/or TDAE (Treated Distilled Aromatic Extracts) and/or MES (Mild Extracted Solvents) and/or naphthenic oils.

Furthermore, the rubber mixture also comprises further additives.

Further additives constitutes essentially the cross-linking system (crosslinkers, sulfur donors and/or elemental sulfur, accelerators, and retarders), anti-ozonants, aging inhibitors, mastication aids, and further activators. The proportion of the total amount of further additives is 3 to 150 phr, preferably 3 to 100 phr, and more preferably 5 to 80 phr.

The total proportion of the further additives also includes 0.1 to 10 phr, preferably 0.2 to 8 phr, more preferably 0.2 to 4 phr, of zinc oxide.

It is usual to add zinc oxide as an activator, usually in combination with fatty acids (e.g., stearic acid) to a rubber mixture for sulfur crosslinking with vulcanization accelerators. The sulfur is then activated for the vulcanization by complexation. The zinc oxide conventionally used has a BET surface area, generally speaking, of less than 10 m²/g. Use may also be made, however, of what is called nano-zinc oxide, having a BET surface area of 10 to 60 m²/g.

The vulcanization of the rubber mixture is carried out preferably in the presence of elemental sulfur or sulfur donors, and certain sulfur donors may at the same time act as vulcanization accelerators. Elemental sulfur or sulfur donors are added to the rubber mixture in the final mixing step, in the quantities familiar to the skilled person (0.4 to 9 phr, elemental sulfur preferably in amounts of 0 to 6 phr, more preferably in amounts of 0.1 to 3 phr). In order to control the required vulcanization time and/or temperature and in order to improve the properties of the vulcanizate, the rubber mixture may comprise substances that influence vulcanization, such as vulcanization accelerators, vulcanization retarders, which in accordance with the invention are included in the above-described additives, and vulcanization activators, as described above.

The rubber mixture of the invention is produced by the processes conventional within the rubber industry, where first of all, in one or more mixing stages, a parent mixture is produced that has all of the constituents apart from the vulcanization system (sulfur and substances that influence vulcanization). Adding the vulcanization system in a final mixing stage produces the completed mixture. The completed mixture is processed further by an extrusion operation, for example, and converted into the appropriate form.

A further object of the invention is to use above-described rubber mixture for producing pneumatic tires, more particularly for producing the tread of a tire and/or a body mixture of a tire, and for producing drive-belts, belts, and hoses.

For use in pneumatic tires, the mixture is brought preferably into the form of a tread and is applied in a known way during the production of the green tire. Alternatively, the tread can be wound onto a green tire, in the form of a narrow strip of rubber mixture. If the tread, as described at the outset, is divided into two, then the rubber mixture finds applications preferably as the mixture for the base.

Production of the rubber mixture of the invention for use as body mixture in vehicle tires takes place as already described for the tread. The difference lies in the shaping after the extrusion operation. the resultant forms of the rubber mixture of the invention for one or more different body mixtures then serve for the construction of a green tire. For use of the rubber mixture of the invention in drive-belts and other belts, more particularly in conveyor belts, the extruded mixture is converted into the appropriate form and, at the same time or afterward, is frequently provided with reinforcing materials, examples being synthetic fibers or steel cords. This usually produces a multi-ply construction, consisting of one and/or a plurality of plies of rubber mixture, one and/or a plurality of plies of the same and/or different reinforcing materials, and one and/or a plurality of further plies of the same and/or a different rubber mixture.

For the use of the rubber mixture of the invention in hoses, preference is often given not to what is called sulfur crosslinking, but instead to peroxidic cross-linking. The hoses are produced in accordance with the method described in Handbuch der Kautschuktechnologie, Dr. Gupta Verlag, 2001, section 13.4. In view of the eco-friendly qualities and the low carcinogenicity, as a result of the absence of polycyclic aromatics in accordance with Directive 76/769/EEC, the rubber mixture of the invention finds use more particularly in food-and-drink hoses, especially in drinking-water hoses, medical hoses, and pharmaceutical hoses.

### DESCRIPTION OF THE PREFERRED EMBODIMENTS OF THE INVENTION

The invention is now to be elucidated in more detail by means of comparative examples and working examples, which are summarized in Tables 1a and 1b and 2a and 2b, respectively. In these Tables, the mixtures marked with “I” are mixtures of the invention, whereas the mixtures marked with “C” are comparative mixtures.

For all of the mixture examples present in the Table, the stated quantity figures are parts by weight, and are based on 100 parts by weight of total rubber (phr).

Mixtures were produced under conventional conditions in two stages in a laboratory tangential mixer. Test specimens were produced by vulcanization from all of the mixtures, and these test specimens were used for determination of materials properties typical for the rubber industry. The test methods employed for the above-described tests on test specimens were as follows:
Shore A hardness at room temperature to DIN 53 505
rebound resilience at room temperature and 70° C. to DIN 53 512
stress values for 100% and 300% tensile strain at room temperature to DIN 53 504
tensile strength at room temperature to DIN 53 504
breaking energy density determined in the tensile test to DIN 53 504, the breaking energy density being the work required for breaking, relative to the volume of the sample
abrasion at room temperature to DIN 53 516 or DIN/ISO 4649
elongation at break at room temperature to DIN 53 504

TABLE 1a

| Constituents | Unit | C1 | C2 | C3 | I1 |
|---|---|---|---|---|---|
| Polyisoprene^{a} | phr | 20 | 20 | 20 | 20 |
| BR^{b} | phr | 44 | 44 | 44 | 44 |
| SSBR^{c} | phr | 36 | 36 | 36 | 36 |
| Silica^{d} | phr | 95 | 95 | 95 | 95 |
| Mineral oil^{e} | phr | 0 | 45 | 0 | 0 |
| Mineral oil^{f} | phr | 45 | 0 | 0 | 0 |
| Mineral oilⁱ | phr | 0 | 0 | 45 | 0 |
| Plasticizer^{g} | phr | 0 | 0 | 0 | 55 |
| ZnO | phr | 2.5 | 2.5 | 2.5 | 2.5 |
| Silane^{h} | phr | 6.84 | 6.84 | 6.84 | 6.84 |
| DPG, CBS, sulfur | phr | 5.6 | 5.6 | 5.6 | 5.6 |

^{a}TSR
^{b}High-cis polybutadiene, cis fraction ≧95 weight %
^{c}SSBR styrene-butadiene rubber, Nipol NS116R, Nippon Zeon
^{d}VN3, Evonik
^{e}TDAE, VIVATEC 500, BP
^{f}MES, CATENEX SNR, Shell
^{g}RTL bio-oil, produced from rubber waste (abraded truck treads), 18.4% solids content present from rubber waste (determined as ash content by TGA), so the amount of RTL oil was selected so as to give the same amount of liquid oil as in the case of C1, C2, and C3
^{h}A1589, Momentive Performance Materials
ⁱRAE, FLAVEX 595, Shell

TABLE 1b

| Properties | Unit | C1 | C2 | C2 | I1 |
|---|---|---|---|---|---|
| Hardness at RT | Shore A | 68 | 68 | 67 | 69 |
| Hardness at 70° C. | Shore A | 65 | 65 | 64 | 63 |
| Rebound at RT | % | 34 | 33 | 30 | 27 |
| Rebound at 70° C. | % | 44 | 45 | 44 | 36 |
| 100% stress value | MPa | 1.9 | 1.9 | 1.9 | 1.7 |
| 300% stress value | MPa | 6.0 | 6.2 | 6.2 | 5.1 |
| Breaking energy density | J/cm³ | 36.7 | 40.0 | 38.4 | 38.7 |
| Elongation at break | % | 625 | 640 | 629 | 693 |
| Tensile strength at RT | MPa | 14.2 | 15.1 | 14.7 | 13.2 |

TABLE 2a

| Constituents | Unit | C4 | C5 | C6 | I2 |
|---|---|---|---|---|---|
| Polyisoprene^{a} | phr | 10 | 10 | 10 | 10 |
| BR^{b} | phr | 18 | 18 | 18 | 18 |
| SSBR^{c} | phr | 72 | 72 | 72 | 72 |
| Silica^{d} | phr | 95 | 95 | 95 | 95 |
| Mineral oil^{e} | phr | 0 | 35 | 0 | 0 |
| Mineral oil^{f} | phr | 35 | 0 | 0 | 0 |
| Mineral oilⁱ | phr | 0 | 0 | 35 | 0 |
| Plasticizer^{g} | phr | 0 | 0 | 0 | 43 |
| ZnO | phr | 2.5 | 2.5 | 2.5 | 2.5 |
| Silane^{h} | phr | 6.84 | 6.84 | 6.84 | 6.84 |
| DPG, CBS, sulfur | phr | 6 | 6 | 6 | 6 |

^{a}TSR
^{b}High-cis polybutadiene, cis fraction ≧95 weight %
^{c}SSBR styrene-butadiene rubber, Nipol NS116R, Nippon Zeon
^{d}VN3, Evonik
^{e}TDAE, VIVATEC 500, BP
^{f}MES, CATENEX SNR, Shell
^{g}RTL bio-oil, produced from rubber waste (abraded truck treads), 18.4% solids content present from rubber waste (determined as ash content by TGA), so the amount of RTL oil was selected so as to give the same amount of liquid oil as in the case of C4, C5, and C6
^{h}A1589, Momentive Performance Materials
ⁱRAE, FLAVEX 595, Shell

TABLE 2b

| Properties | Unit | C4 | C5 | C6 | I2 |
|---|---|---|---|---|---|
| Hardness at RT | Shore A | 73 | 73 | 75 | 74 |
| Hardness at 70° C. | Shore A | 69 | 69 | 70 | 69 |
| Rebound at RT | % | 28 | 26 | 22 | 23 |
| Rebound at 70° C. | % | 48 | 48 | 46 | 42 |
| 100% stress value | MPa | 3.0 | 2.8 | 3.0 | 2.7 |
| 300% stress value | MPa | 9.9 | 9.9 | 10.2 | 8.7 |
| Breaking energy density | J/cm³ | 27.3 | 27.3 | 31.5 | 36.6 |
| Elongation at break | % | 442 | 443 | 466 | 535 |
| Tensile strength at RT | MPa | 14.5 | 14.9 | 16.2 | 16.2 |
| Abrasion | mm³ | 143 | 127 | 131 | 131 |

Looking at the mixture compositions as set out in Tables 1a and 2a and at the resultant physical proper-ties as set out in Tables 1b and 2b, it may be stated, in summary, that by comparison with the reference mixtures, the physical properties of rubber mixtures of the invention remain at the same level. With regard to the stress properties at high tensile strain (300%) there is even a distinct improvement evident from I1 and I2 in comparison with the corresponding comparative mixtures.

It is understood that the foregoing description is that of the preferred embodiments of the invention and that various changes and modifications may be made thereto without departing from the spirit and scope of the invention as defined in the appended claims.

What is claimed is:

1. A rubber mixture comprising:
at least one rubber, the rubber being selected from the group consisting of a polar rubber and a nonpolar rubber or a mixture thereof;
at least one filler, the filler being selected from the group consisting of a pale filler and a dark filler or a mixture thereof;
a plasticizer, the plasticizer being free from polycyclic aromatics, and the plasticizer having been produced on the basis of carbon-containing wastes from the production of tires and other industrial rubber products; and
further additives.

2. The rubber mixture of claim 1, wherein the at least one rubber is selected from the group consisting of a natural polyisoprene, a synthetic polyisoprene, a butadiene rubber, and a styrene-butadiene rubber, or a mixture thereof.

3. The rubber mixture of claim 1, wherein the at least one filler is a pale filler and is silica.

4. The rubber mixture of claim 1, wherein the at least one filler is a dark filler and is carbon black.

5. The rubber mixture of claim 1, wherein the plasticizer has been produced by direct catalytic liquefaction.

6. The rubber mixture of claim 1, wherein an amount of the plasticizer is of from 0.1 to 150 phr.

7. A method of producing a tire comprising preparing the rubber mixture of claim 1.

8. The method as claimed in claim 7 for producing the tread or a body mixture of a tire.

9. A method of producing a belt, drive-belt or hose comprising preparing the rubber mixture of claim 1.
